(19) United States
(12) Patent Application Publication
(10) Pub. No.: US 2008/0120723 A1
(43) Pub. Date: May 22, 2008

(54) Methods, systems and computer program products for authorizing access to features of software applications

(75) Inventors: Kermon Carter, Roanke, VA (US); Matthew Hunter, Roanoke, VA (US); Craig Balliet, Roanoke, VA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/590,106

(22) Filed: Oct. 31, 2006

(51) Int. Cl. H04L 9/32

(52) U.S. Cl. 726/26

(57) ABSTRACT

Methods for securing a software application are provided. The software application is scanned to obtain a list of configurable components and/or actions in the software application so as to allow ones of the configurable components and/or actions on the list to be enabled or disabled based on an authorization level of a user or a group of users of the software application. Related systems and computer program products are also provided herein.

### FIELD OF THE INVENTION

The present invention generally relates to security for software applications and, more particularly, methods, systems and computer program products for authorization in software applications.

### BACKGROUND OF THE INVENTION

Security in software applications is typically non-existent or is broad and action-based. For example, a user or groups of users may be granted update or read-only rights to a particular window or region of the software application. Providing this type of security for software applications places users in larger groups with broad-based similar functionality and, therefore, does not allow individuals or small groups of individuals to be treated differently. For example, in a conventional software application the components are shown/hidden, enabled/disabled and the like according to the functionality of the group. Thus, conventional security applications for software applications cannot hide a particular component that may contain sensitive information from a group of users or a single user.

### SUMMARY OF EMBODIMENTS OF THE INVENTION

Some embodiments of the present invention provide methods for securing a software application. The software application is scanned to obtain a list of configurable components and/or actions in the software application so as to allow ones of the configurable components and/or actions on the list to be enabled or disabled based on an authorization level of a user or a group of users of the software application.

In further embodiments of the present invention, the software application may be scanned for objects associated with the configurable components and/or actions to obtain the list of configurable components.

In still further embodiments of the present invention, the obtained list of configurable components and/or actions may be stored. The list of configurable components and/or actions may be modified such that the components and/or actions are enabled or disabled based on the authorization level of the user or the group of users.

In some embodiments of the present invention, a request for a functionality of the software application may be received and the modified list of components and/or actions may be loaded responsive to the request before acting on the request for the functionality of the software application. The requested functionality of the software application may be provided such that the components and/or actions of the software application are defined by the modified list of components and/or actions based on the authorization level of the user or the group of users.

In further embodiments of the present invention, the authorization level is received, associated with the user or the group of users of the software application and the user or the group of users is authorized to access portions of the requested functionality of software application based on the authorization level associated with the user or the group of users.

In still further embodiments of the present invention, access to the configurable components and/or actions may be enabled or disabled based on the authorization level of the user or the group of users of the software application.

Although embodiments of the present invention are discussed herein with respect to method embodiments, related systems and computer program products are also provided.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims

### BRIEF DESCRIPTION OF THE FIGURES

Other features of the present invention will be more readily understood from the following detailed description of exemplary embodiments thereof when read in conjunction with the accompanying drawings, in which:

FIG. 1 is a block diagram of a data processing system suitable for use in devices according to some embodiments of the present invention.

FIG. 2 is a more detailed block diagram of data processing systems according to some embodiments of the present invention.

FIG. 3 is a block diagram of a system according to some embodiments of the present invention.

FIGS. 4 through 6 are screen shots illustrating various aspects of some embodiments of the present invention.

FIGS. 7 and 8 are flowcharts illustrating operations for providing security to software applications according to various embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of devices, methods and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

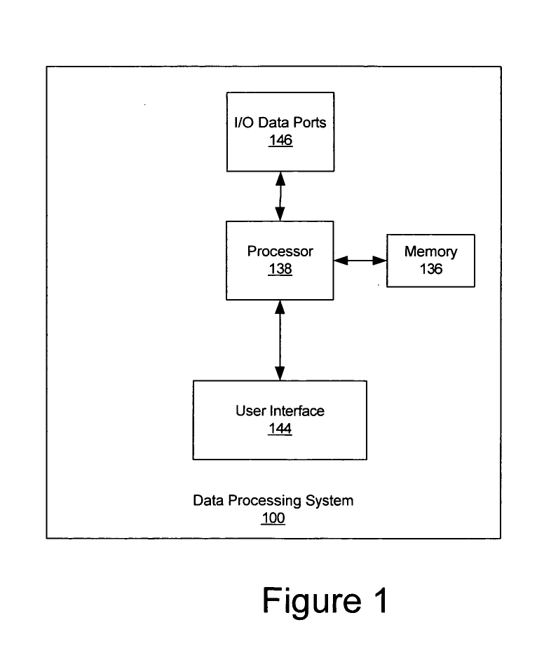

Embodiments of the present invention will be discussed in detail herein with respect to FIGS. 1 through 8. As discussed above, conventional software applications do not provide adequate security features. Thus, according to some embodiments of the present invention a granular approach to application security may be provided, which may allow enabling/disabling components and/or actions, showing/hiding components and/or actions and the like on a single component or action basis. In other words, each data entry field, label, panel, list, scroll bar, menu item, button, and the like in the software application can be enabled or disabled on a component by component basis in the software application. Furthermore, in some embodiments of the present invention data entry fields may be marked required or not required. The components and/or actions that are enabled or disabled may be defined by an authentication level associated with a user or a group of users of the software application.

As will be discussed further below, the entire software application may be scanned during the development process to discover/obtain a list of configurable components or actions in the software application. The discovery of the list of configurable components may be automated so that the user does not need to actively define the list of components. Supplementing the component level security according to some embodiments of the present invention is action-based security, which may allow for fine control over functionality.

As used herein, an “action” refers to a process, such as a save order, generate customer report, delete user, open security editor window and the like. An action is application-wide and is not tied to any particular window or other user interface component. As used herein, a “component” refers to anything that a user can view on the display, such as data entry fields, labels, panels, lists, scroll bars, menu items, buttons, and the like. Action-based security according to some embodiments of the present invention can be used to control non-user interface (non-UI) processes, such as web services. Action-based security combined with component-level (UI-based) security may provide a comprehensive blanket of security for a software application as will be discussed further herein with respect to FIGS. 1 through 8.

Details of various embodiments of the present invention will be discussed below with respect to FIGS. 1 through 8. Referring first to FIG. 1, an exemplary embodiment of a data processing system 100 suitable for use in accordance with some embodiments of the present invention will be discussed. The data processing system 100 typically includes a user interface 144, such as a keyboard, keypad, touchpad or the like, I/O data ports 146 and a memory 136 that communicate with a processor 138. The I/O data ports 146 can be used to transfer information between the data processing system 100 and another computer system or a network. These components may be conventional components, such as those used in many conventional data processing systems, which may be configured to operate as described herein.

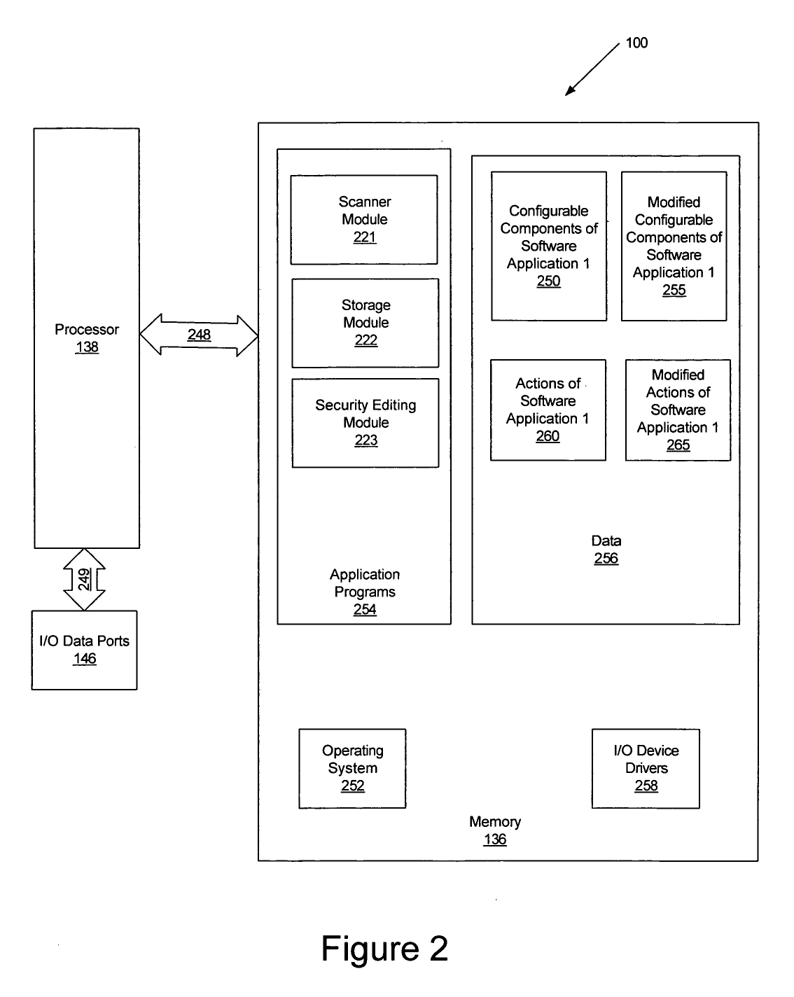

Referring now to FIG. 2, a more detailed block diagram of the data processing system 100 in accordance with some embodiments of the present invention will be discussed. The processor 138 communicates with the memory 136 via an address/data bus 248 and the I/O data ports 146 via an address/date bus 249. The processor 138 can be any commercially available or custom microprocessor. The memory 136 is representative of the overall hierarchy of memory devices containing the software and data used to implement the functionality of the data processing system 100. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 100: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 100 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As illustrated in FIG. 2, the data 256 according to some embodiments of the present invention may include one or more lists of configurable components 250, one or more modified lists of configurable components 255, one or more lists of actions 260 and one or more lists of modified actions 265. Although the lists of configurable components 250 and 255 are shown as separate from the actions 260 and 265 in FIG. 2, embodiments of the present invention are not limited to this configuration. For example, the lists of configurable components 250 and 255 may be combined with the actions 260 and 265 without departing from the scope of the present invention. The details with respect to this data will be discussed further below.

Although the data 256 only includes one of each type of file 250, 255, 260 and 265, embodiments of the present invention are not limited to this configuration. Any number of any of these files may be provided without departing from the scope of the present invention.

As further illustrated in FIG. 2, the application programs 254 may include a scanner module 221, a storage module 222 and a security editing module 223 according to some embodiments of the present invention. While the present invention is illustrated, for example, with reference to the scanner module 221, the storage module 222 and the security editing module 223 being application programs in FIG. 2, as will be appreciated by those of skill in the art, other configurations may also be utilized while still benefiting from the teachings of the present invention. For example, the scanner module 221, the storage module 222 and the security editing module 223 may also be incorporated into the operating system 252 or other such logical division of the data processing system 100. Thus, the present invention should not be construed as limited to the configuration of FIG. 2, but is intended to encompass any configuration capable of carrying out the operations described herein.

Furthermore, while the scanner module 221, the storage module 222 and the security editing module 223 are illustrated in a single data processing system, as will be appreciated by those of skill in the art, such functionality may be distributed across one or more data processing systems. Thus, the present invention should not be construed as limited to the configuration illustrated in FIGS. 1 through 2, but may be provided by other arrangements and/or divisions of function between data processing systems.

In particular, the scanner module 221 is configured to scan a software application to obtain a list of configurable components and/or actions of the software application. The software application can be any software application without departing from the scope of the present invention. As will be discussed further below, ones of the configurable components and/or actions on the list may be enabled or disabled based on an authorization level of the user or the group of users of the software application.

The authorization level of the user or the group of users may be customizable. A provider/owner of the software application may define the features of the software application that can be accessed by an individual user or a group of users. For example, a software application/database being used by a hospital to store confidential patient records may give access to certain things to doctors, but not to nurses. Furthermore, the role of the user may also be used to determine the authorization level. For example, a doctor acting as a care provider may have access to different things than a doctor acting as researcher.

In some embodiments of the present invention, the scanner module 221 may be configured to scan the objects (classes) of the software application for components and/or actions. This determination of components and/or actions may be automated so that the user does not have to actively obtain the list of components and/or actions present in the software application. In some embodiments of the present invention, the scanner module 221 may be configured to traverse the hierarchical component structure of a window to collect the components of a window in the software application and reflection may be used to obtain information about actions. Components may be collected if they have been named, which may allow miscellaneous window decorations and other components (if desired) to be omitted from the component list. The storage module 222 may be configured to store the obtained list of components and actions.

The security editing module 223 may be configured to modify the obtained list of configurable components and/or actions or to allow the obtained list of configurable components and/or actions to be modified such that the components and/or actions are enabled or disabled based on the authorization level of the user or the group of users. The security editing module 223 may be configured to allow the list of components/actions to be modified such that visibility or modification rights (or requirement or color) to individual components may be enabled or disabled based on the authorization level associated with the user or the group of users. For example, in some embodiments of the present invention, the authorization level may be based on a user role. Furthermore, actions may also be configured to be allowed or disallowed. The modified list of components and/or actions may be stored by the storage module 222.

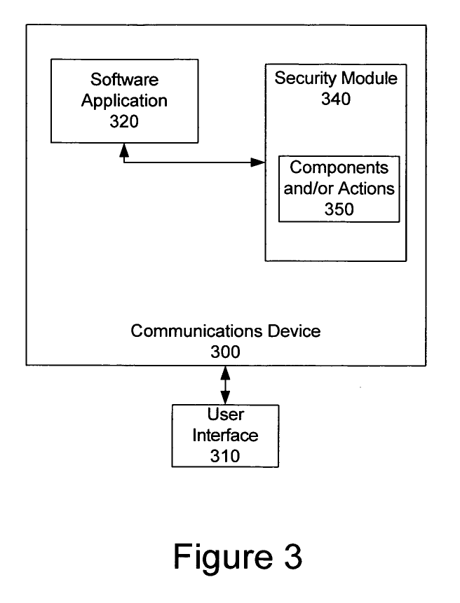

Referring now to FIG. 3, a block diagram of a system that may be used in accordance with some embodiments of the present invention will be discussed. As illustrated in FIG. 3, the system includes a communications device 300 and a user interface 310. Although the user interface 310 is illustrated as being separate from the communications device 300, embodiments of the present invention are not limited to this configuration. For example, the user interface 310 and the communications device 300 may be combined.

As further illustrated in FIG. 3, the communications device 300 is running a software application 320 in accordance with some embodiments of the present invention and includes a security module 340. The security module 340 may be configured to enable or disable access to the configurable components and/or actions based on the authorization level of the user or the group of users of the software application.

Exemplary operations in accordance with some embodiments of the present invention will now be discussed with respect to FIGS. 2 and 3. The software application 320 may receive a request for a functionality of the software application and the list of modified components and/or actions 350 may be loaded before acting on the request for the functionality of the software application. The requested functionality of the software application 320 may be provided such that the components and/or actions of the software application are defined by the modified list of components based on the authorization level of the user or the group of users.

For example, in some embodiments of the present invention, the software application may receive a request for a functionality of the software application, such as a request for a particular window. The modified list of components and/or actions may be loaded before acting on the request for the functionality of the software application. The requested functionality of the software application may be provided such that the components and/or actions of the software application are defined by the modified list of components based on the authorization level of the user or the group of users.

According to some embodiments of the present invention, security may be implemented in the software application when a window is loaded/displayed. For example, the security configuration for a window is typically loaded just before the window is displayed and access to components/actions are enabled or disabled at this time based on the list of components/actions. As discussed above, this process is hidden from the user and may be coded into the master window from which all application windows may be created. According to some embodiments of the present invention, security checks are built-in to the mechanisms by which the application program enables or disables components/actions, so that a programmer does not need to constantly check security himself before changing the access to components pro grammatically.

It will be understood that according to some embodiments of the present invention, the scanner module 221 and the implementation parts of embodiments of the present invention may be language specific, since they must typically integrate tightly with the software application. For example, .NET and Java implementations of the present invention may be provided according to some embodiments of the present invention. The security editing module 223 may be independent of the language and, therefore, may not be so restricted. Some embodiments of the present invention provide a security editing module 223 written in Java.

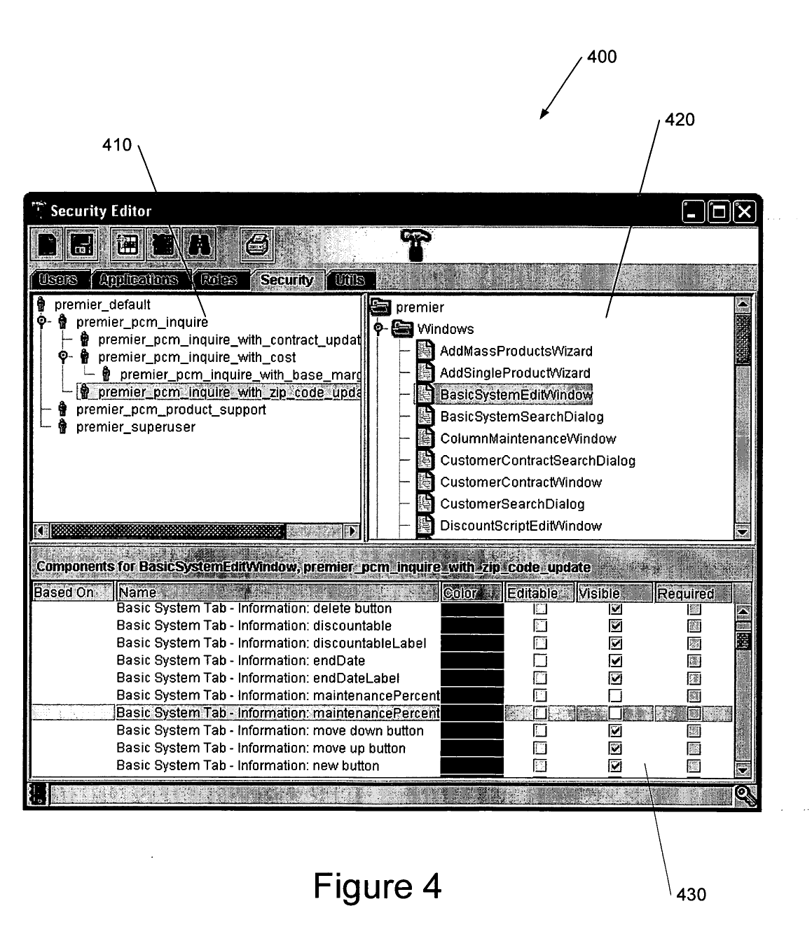

Referring now to FIGS. 4 through 6, screen shots in accordance with some embodiments of the present invention will be discussed. Referring first to FIG. 4, window 400 is an exemplary Security Editor window 400 that may be provided by the security editor module. Roles may be selected in the top left pane 410. For example, a drag and drop technique may be used to create a role hierarchy, and a role may inherit the settings from the parent role. Windows of the software program may be selected in the top right pane 420, and component security settings may be made in the bottom pane 430. A gray background check box indicates that the value is “inherited” from the parent role. A white background check box indicates that the value is set for this role, regardless of the inherited value.

Furthermore, in the bottom pane 430, the left column illustrates what role the current settings are based on. For example, if the “premier_pcm_inquire” role has the “Basic System Tab—Information: new button” marked as non-visible, and this setting is not overridden by the “premier_pcm_inquire_with_zip_code_update” role, then “premier_pcm_inquire” should show up in the left column for this component. The color, editable, visible, and required columns may allow a user to configure these attributes of the components. For example, in some embodiments of the present invention, clicking on a color swatch in the column may produce a palette selection tool should a user wish to change the color of this component. Clicking the editable, visible, or required checkboxes may allow these attributes to be changed or “overridden” for this role. As discussed above, all roles in the hierarchical structure beneath this role will inherit these settings.

It will be understood that the screen shot of FIG. 4 is provided for exemplary purposes only and that embodiments of the present invention are not limited to the configurations set out therein.

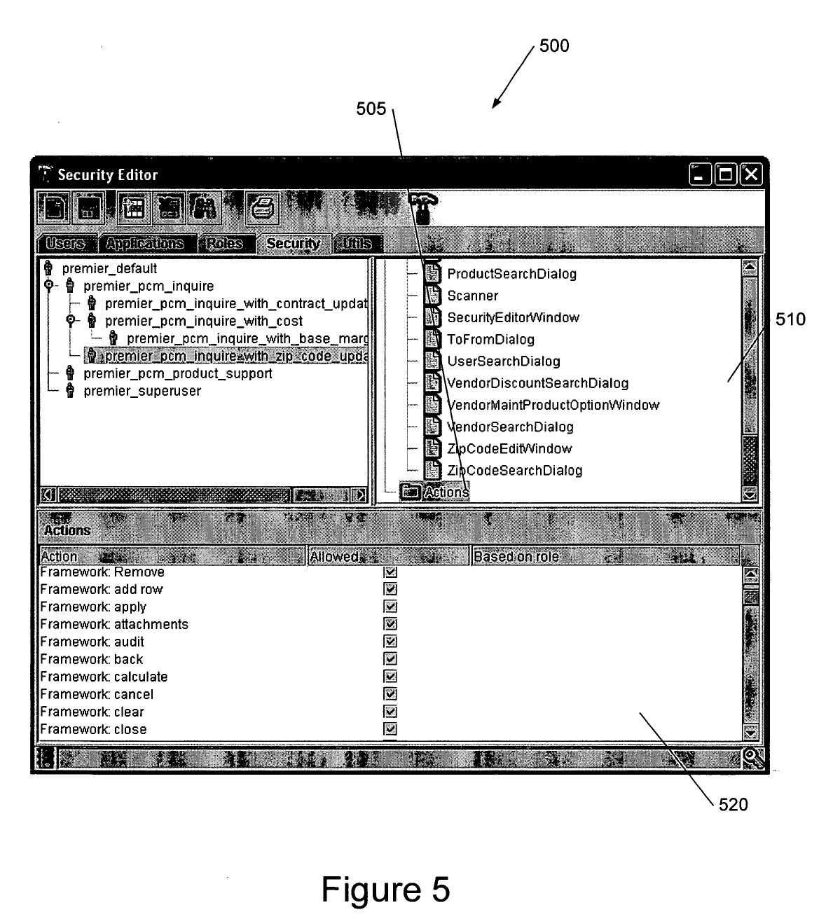

Referring now to FIG. 5, the window 500 is an exemplary window including Actions 505 that may be selected beneath the window list in the top right pane 510. In particular, selecting Actions 505 in the top right pane 510 may cause the list of actions to appear in the bottom pane 520. Actions typically have one configurable attribute, for example, allowed or disallowed, which can be configured in the bottom pane 520 of FIG. 5.

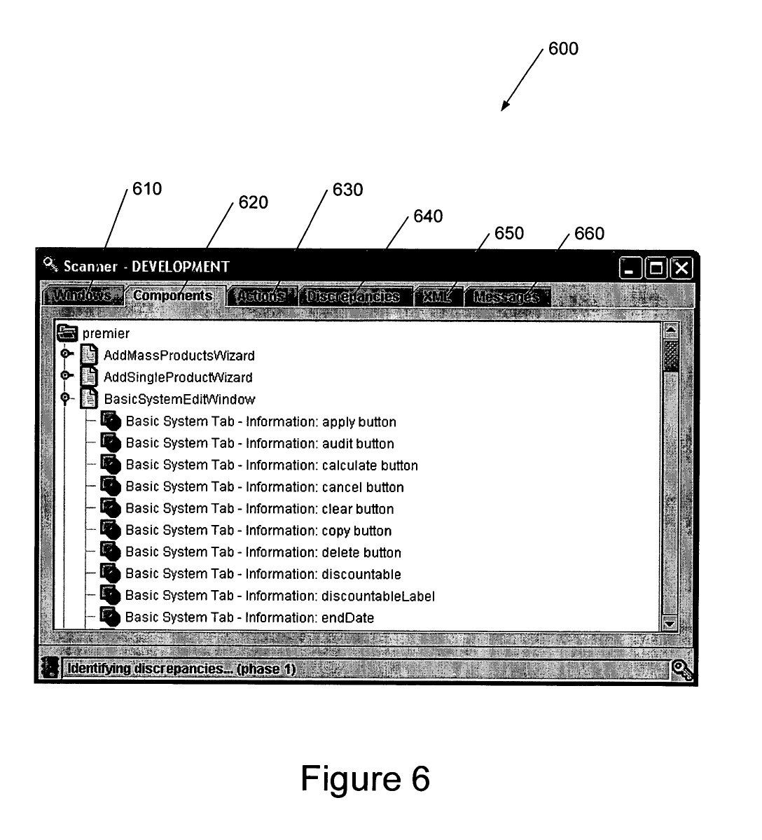

As further illustrated in FIG. 6, an exemplary scanner window 600 associated with the scanner module is provided. The different tabs of the window provide different information about the scanned application. In particular, the scanner module according to some embodiments of the present invention is a developer's tool and, therefore, may be written with the developer in mind, unlike the security editing module, which may be used by others with appropriate authorization. In some embodiments of the present invention, when the scanner module is invoked, it will scan through all of the programming objects in the application. As used herein, “object” refers to an “object type” or “class.” For example, an object could be anything from a user, to a call ticket, to a price of a product, to a component on a window, and the like.

The different tabs of the scanner window 600 will now be discussed. First, the Windows tab 610 of scanner window 600 may show all of the objects in the application. The windows are filtered out of the list of objects, and then this list is updated to show just the list of windows. In some embodiments of the present invention, a selection button (not shown) will allow a user to view either all objects or only window objects. The Components tab 620 illustrates a list of windows and the named components that have been added to those windows. The Actions tab 630 illustrates a list of collected actions. The Discrepancies tab 640 illustrated the differences between what the scanner has discovered in the application and what is currently recorded in the security database. When updating the production environment, it is may be comforting to see what will be changed before committing the changes. The XML tab 650 illustrates the actual XML code that will be sent from the scanner module to the storage module for updating the security data. This may be useful during a debugging process. Finally, the Messages tab 660 illustrates any problems or concerns that may occur during the process. After review, a submit button (not shown) may allow the user to submit these changes to the database.

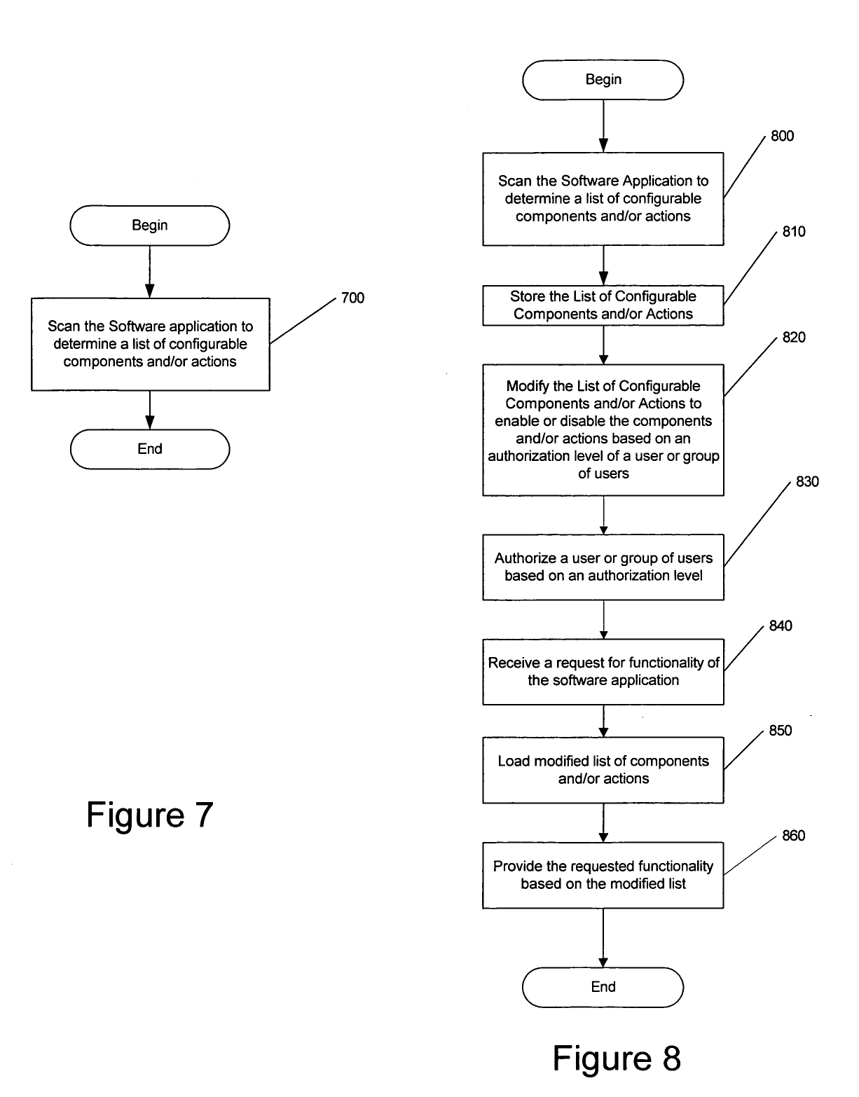

Referring now to the flowchart diagrams of FIGS. 7 and 8, various methods of providing security in software applications according to some embodiments of the present invention will be discussed. Referring first to FIG. 7, operations begin at block 700 by scanning the software application to obtain a list of configurable components and/or actions in the software application so as to allow ones of the configurable components and/or actions on the list to be enabled or disabled based on an authorization level of a user or a group of users of the software application.

Referring now to FIG. 8, operations begin at block 800 by scanning the software application to obtain a list of configurable components and/or actions in the software application so as to allow ones of the configurable components and/or actions on the list to be enabled or disabled based on an authorization level of a user or a group of users of the software application. In some embodiments of the present invention, the software application may be scanned for objects associated with the configurable components and/or actions to obtain the list of configurable components. The obtained list of configurable components and/or actions may be stored (block 810).

The list of configurable components and/or actions may be modified such that the components and/or actions are enabled or disabled based on the authorization level of the user or the group of users (block 820). A user or group of users of the software application may be authorized (block 830). For example, the authorization level associated with the user or the group of users of the software application may be received and the user or group of users may be authorized to access portions of the requested functionality of software application based on the authorization level of the user or the group of users. A request for a functionality of the software application may be received, such as a request for a particular window (block 840). The modified list of components and/or actions may be loaded responsive to the request before acting on the request for the functionality of the software application (block 850). The requested functionality of the software application may be provided such that the components and/or actions of the software application are defined by the modified list of components and/or actions based on the authorization level of the user or the group of users (block 860).

As discussed above, the order of the operations discussed with respect to FIGS. 7 and 8 may be changed without departing from the scope of the present invention. For example, the operations discussed with respect to blocks 840 and 850 above may be reversed without departing from the scope of the present invention. For example, the security settings (“modified list of components”) may be loaded and stored. Then, incoming requests may be acted up or denied based on the security settings. In particular, the settings for actions may be loaded first. A request for an action may be received from anywhere at any time, so these settings are kept in memory so that they can be accessed quickly to respond to the request. For example, an action request to open a particular window may be received. If authorized, the window may be loaded. At this point, the component-based security settings may be loaded for that window. When the window is populated with components without yet being shown, the security settings may be applied to those components. These security settings will remain in memory at least as long as the window is in memory so that requests related to the components on that window can be quickly acted upon or denied.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method for securing a software application, comprising scanning the software application to obtain a list of configurable components and/or actions in the software application so as to allow ones of the configurable components and/or actions on the list to be enabled or disabled based on an authorization level of a user or a group of users of the software application.

2. The method of claim 1, wherein scanning the software application further comprises programmatically scanning the software application for objects associated with the configurable components and/or actions to obtain the list of configurable components.

3. The method of claim 1, further comprising storing the obtained list of configurable components and/or actions.

4. The method of claim 3, further comprising programmatically modifying the list of configurable components and/or actions such that the components and/or actions are enabled or disabled based on the authorization level of the user or the group of users.

5. The method of claim 4, further comprising:
receiving a request for a functionality of the software application;
loading the modified list of components and/or actions before acting on the request for the functionality of the software application; and
providing the requested functionality of the software application such that the components and/or actions of the software application are defined by the modified list of components and/or actions based on the authorization level of the user or the group of users.

6. The method of claim 5, wherein receiving a request is preceded by:
receiving the authorization level associated with the user or the group of users of the software application; and
authorizing the user or group of users to access portions of the requested functionality of software application based on the authorization level associated with the user or the group of users.

7. The method of claim 1, further comprising programmatically enabling or disabling access to the configurable components and/or actions based on the authorization level of the user or the group of users of the software application.

8. A system for securing a software application, comprising:
a scanner module configured to scan the software application to obtain a list of configurable components and/or actions in the software application so as to allow ones of the configurable components and/or actions on the list to be enabled or disabled based on an authorization level of a user or a group of users of the software application.

9. The system of claim 8, wherein the scanner is further configured to scan the software application for objects associated with the configurable components and/or actions to obtain the list of configurable components.

10. The system of claim 8, further comprising a storage module configured to store the obtained list of configurable components and/or actions.

11. The system of claim 10, further comprising a security editing module configured to modify the list of configurable components and/or actions such that the components and/or actions are enabled or disabled based on the authorization level of the user or the group of users.

12. The system of claim 11, wherein the software application is configured to:
receive a request for a functionality of the software application;
load the modified list of components and/or actions before acting on the request for the functionality of the software application; and
provide the requested functionality of the software application such that the components and/or actions of the software application are defined by the modified list of components and/or based on the authorization level of the user or the group of users.

13. The system of claim 8, further comprising a security module configured to enable or disable access to the configurable components and/or actions based on the authorization level of the user or the group of users of the software application.

14. A computer program product for securing a software application, the computer program product comprising:
computer readable storage medium having computer readable program code embodied in said medium, the computer readable program code comprising:
computer readable program code configured to scan the software application to obtain a list of configurable components and/or actions in the software application so as to allow ones of the configurable components and/or actions on the list to be enabled or disabled based on an authorization level of a user or a group of users of the software application.

15. The computer program product of claim 14, wherein the computer readable program code configured to scan comprises computer readable program code configured to scan the software application for objects associated with the configurable components and/or actions to obtain the list of configurable components.

16. The computer program product of claim 14, further comprising computer readable program code configured to store the obtained list of configurable components and/or actions.

17. The computer program product of claim 16, further comprising computer readable program code configured to modify the list of configurable components and/or actions such that the components and/or actions are enabled or disabled based on the authorization level of the user or the group of users.

18. The computer program product of Claim method of claim 17, further comprising:
computer readable program code configured to receive a request for a functionality of the software application;
computer readable program code configured to load the modified list of components and/or actions before acting on the request for the functionality of the software application; and
computer readable program code configured to provide the requested functionality of the software application such that the components and/or actions of the software application are defined by the modified list of components and/or actions based on the authorization level of the user or the group of users.

19. The computer program product of claim 18, further comprising:
computer readable program code configured to receive the authorization level associated with the user or the group of users of the software application; and
computer readable program code configured to authorize the user or group of users to access portions of the requested functionality of software application based on the authorization level associated with the user of the group of users.

20. The computer program product of claim 14, further comprising computer readable program code configured to enable or disable access to the configurable components and/or actions based on the authorization level of the user or the group of users of the software application.
